(19) United States
(12) Patent Application Publication
(10) Pub. No.: US 2014/0261745 A1
(43) Pub. Date: Sep. 18, 2014

(54) PROJECTION WELDED PRESSURE RELIEF VALVE ASSEMBLY

(71) Applicant: Charles Thomas HAYES, Columbus, OH (US)

(72) Inventor: Charles Thomas HAYES, Columbus, OH (US)

(21) Appl. No.: 13/856,668

(22) Filed: Apr. 4, 2013

Related U.S. Application Data
(60) Provisional application No. 61/798,203, filed on Mar. 15, 2013.

(51) Int. Cl. F16K 17/04

(52) U.S. Cl. CPC F16K 17/04
USPC 137/15.18; 137/315.04

(57) ABSTRACT

This invention relates to a pressure relievable tank comprising a cylinder, a pressure relief valve having a housing with an upper end, a lower end and a sidewall disposed therebetween, a flange connected the upper end of the housing, and a bottom having a central aperture and an upwardly facing rim surrounding the central aperture. The bottom is connected to the lower end of the housing and the bottom and sidewall form a cavity. A retainer is fixed in the upper end of the housing, a seal is disposed in the lower end of the housing, and a spring is compressed between the retainer and the seal for holding the seal against the upwardly facing rim. A projection weld welds the flange to the cylinder.

### CROSS REFERENCE TO RELATED APPLICATIONS

This application claims the benefit of U.S. Provisional application 61/798,203, filed Mar. 15, 2013, the disclosure of which is incorporated by reference in its entirety.

### FIELD OF THE INVENTION

This invention relates generally to a cylinder having a pressure relieve valve. This invention relates specifically to a cylinder having a pressure relief valve projection welded to it and methods of projection welding a pressure relief valve to a cylinder.

### BACKGROUND OF THE INVENTION

Portable cylinders containing pressurized products are typically provided with a venting apparatus that prevents the cylinder from exploding by venting the cylinder if the pressure exceeds a safe level. A common cause of excessive cylinder pressure is heat, such as sunlight or fire. Heat excites the molecules in the tank, causing them to attempt to expand and increasing cylinder pressure. One venting apparatus is a burst disk, which bursts when the pressure inside a cylinder exceeds a maximum safe level. When the burst disk bursts, the contents of the cylinder are vented until the internal cylinder pressure equals atmospheric pressure. Burst disks are typically used with non-flammable materials.

When flammable materials are stored in a tank, it is desired to vent excessively pressurized cylinders in a controlled manner, preferable without venting the entire tank. For example, if a cylinder is in a fire, then it is preferred that only the amount of flammable contents necessary to reduce the internal cylinder pressure to a safe level be vented so that only a minimum amount of fuel is added to the fire. To vent flammable materials, a venting apparatus known as a pressure relieve valve (PRV) is used. A pressure relief valve vents the contents of the cylinder when the internal cylinder pressure exceeds a maximum safe level and reseals when the internal cylinder pressure drops to a level below the maximum safe level.

Historically, a PRV housing is brazed or seam welded to a tank and the internal components of the PRV valve, typically including a rubber seal, are installed into the PRV housing. While one may desire to preassemble the PRV before seam welding or brazing it in the cylinder, the heat generated by brazing or seam welding is excessive and can compromise the rubber seal. Care must be taken when assembling a PRV because certain torque levels or spring compression levels must be accurately and consistently maintained to provide the proper pressure upon which the PRV will vent the cylinder. Preassembling a PRV could eliminate the need to install the internal components in the housing after the housing is welded or brazed to the cylinder. Additionally, a preassembled PRV could be purchased from a vendor and then installed at a cylinder manufacturing facility.

### SUMMARY OF THE INVENTION

This invention relates to a pressure relievable tank comprising a cylinder, a pressure relief valve having a housing with an upper end, a lower end and a sidewall disposed therebetween, a flange connected the upper end of the housing, and a bottom having a central aperture and an upwardly facing rim surrounding the central aperture, whereas the bottom is connected to the lower end of the housing and the bottom and sidewall form a cavity, a retainer fixed in the upper end of the housing, a seal disposed in the lower end of the housing, and a spring compressed between the retainer and the seal for holding the seal against the upwardly facing rim, and a projection weld welding the flange to the cylinder.

This invention also relates to a process of manufacturing a pressure relievable tank, comprising providing a first cylinder component having a pressure relief valve receiving area, whereas the pressure relief valve receiving area has a projection and defines an aperture, providing a pressure relief valve having a housing with an upper end, a lower end and a sidewall disposed therebetween, a flange connected the upper end of the housing, a bottom having a central aperture and an upwardly facing rim surrounding the central aperture, whereas the bottom is connected to the lower end of the housing and the bottom and sidewall form a cavity, providing a welder with an upper electrode and a lower electrode, placing the first cylinder component in the welder with a lower face of the pressure relief valve receiving area resting on the lower electrode, depositing the pressure relief valve in the pressure relief valve receiving area, moving the upper electrode towards the lower electrode, pushing the flange of the pressure relief valve against the projection with the upper electrode, and projection welding the flange to the cylinder component where the projection meets the flange.

### BRIEF DESCRIPTION OF THE DRAWINGS

FIG. 1 is a side view of a cylinder of the invention with a section of an upper portion removed to show a PRV.

FIG. 2 is an enlarged section view of a PRV of the invention.

FIG. 3 is an enlarged section view of a PRV installed in a cylinder.

FIG. 4 is an enlarged section view of formed pocket of an upper portion of a cylinder.

FIG. 5 is a partial view of a welder used for projection welding a PRV to the upper portion of a cylinder.

FIG. 6 is a perspective view of a lower electrode and base of the welder of FIG. 5.

### DETAILED DESCRIPTION OF THE INVENTION

FIG. 1 shows a cylinder 100 made from a first cylinder component 120 and a second cylinder component 130. Here, the first cylinder component is an upper portion 120 and the second cylinder component is a lower portion 130. The upper portion has a top 122 and sidewalls 124 that connect to the top and terminate in a lower rim 126. Typically, the upper portion 120 is formed from a single piece of material and has an upwardly convex top 122. The lower portion 130 has a bottom 132 and sidewalls 134 that connect to the bottom 132 and terminate in an upper rim 136. The upper portion 120 and the lower portion 130 are assembled together to form a cylinder with an internal cavity 101 by welding the lower rim 126 to the upper rim 136 with a seam weld 138. Typically, the seam weld is a performed by an automated MIG welder.

The bottom 132 of the cylinder may have deformations 108 to provide stability to the cylinder when it is placed in the upright position. Other methods of providing stability, such as a ring welded to the bottom of the cylinder may be provided. A valve 110 is typically located on the top 122 of the upper portion 120. A handle and valve protector 102 surrounds the valve 110 and is disposed on top 122 of the upper portion 120.

As shown in FIGS. 1 and 3, the top 122 of the cylinder includes a PRV receiving area 140 that defines an aperture 112 with a diameter 114 for receiving a pressure relief valve 10. FIG. 4 shows an enlarged area of the PRV receiving area 140. FIG. 4 shows the PRV receiving area 140 that includes a formed pocket 142 that includes an inner substantially flat portion 144 transitioning to sloped sidewalls 146, and an outer portion 148 connected to the sloped sidewalls 146. Typically the formed pocket is substantially circular. Formed in the outer portion 148 is a substantially circular projection 150 that surrounds the sidewalls 146. The projection 150 extends above an outer surface 152 of the outer portion 148 a distance 154 typically between 0.010 and 0.100 inches, more typically between 0.015 and 0.080 inches, more typically between 0.020 and 0.060 inches, more typically between 0.025 and 0.040 inches, and most typically between 0.027 and 0.033 inches. An upper edge 156 of the projection 150 defines a diameter 158. While this embodiment provides the PRV receiving area in the upper portion 120 of the cylinder, the PRV receiving area could also be located on the lower portion 130 of the cylinder.

FIG. 2 shows a pressure relief valve 10 having a housing 12 with an upper end 14, a lower end 16, and a sidewall 18 disposed therebetween. An outwardly radial flange 20 is connected to the housing at the upper end 14, and a bottom 26 with a central aperture 28 and an upwardly facing rim 30 surrounding the central aperture is connected to the housing at the lower end 16. The flange 20 has an outside diameter 22 that is larger than the diameter 114 of the cylinder aperture 112. The sidewall 18 has an outside diameter 24 sized to fit in the cylinder aperture 112. The bottom 26 and sidewall 18 form a substantially hollow cavity 52.

Disposed in the housing 12 is a seal 32, a safety seat 34, a spring 36, and a retainer 38. The seal 32 has a lower side 40 that seals against the upwardly facing rim 30 and an upper side 42. The safety seat 34 has a seal retainer 44 on a lower end 45 and a spring receiver 46 on an upper end 47. The spring 36 is compressed between the safety seat 34 and the retainer 38. The compressed spring 36 biases the seal 32 against the rim 30 to provide a seal between the internal cavity 101 of the cylinder and the atmosphere.

The spring is preloaded to a predetermined force sufficient to maintain a working pressure in the cylinder and that will allow the spring to further compress when a maximum cylinder pressure is exceeded. The spring is preloaded by pushing the retainer 38 into the housing 12 to compress the spring and then fixing the retainer 38 at in a position at the upper end of the housing by peening the housing against the retainer. Alternatively, internal threads 48 may be provided on the upper end 14 of the housing to mate with external threads 50 on the retainer. The retainer is then threaded in to a certain torque known to produce a certain compressive force on the spring or can be threaded in a certain number of threads in which the number of threads corresponds to a certain distance the spring is compressed. The distance necessary to compress the spring can be determined by the formula d=F/k where d is the distance in inches, F is the predetermined force in pounds, and k is the spring constant in pounds/inch. After threading the retainer into the housing, the housing may be peened to lock the retainer in place.

The spring force necessary to maintain the seal between the seal 32 and upwardly facing rim 30 is a function of the area of the seal 32 exposed to the internal tank pressure and the predetermined maximum cylinder pressure, also known as the start to discharge pressure. For example, if the area of the central aperture 28 that exposes the seal 32 to the cylinder pressure is 0.10 square inches and the predetermined designed start to discharge pressure is 375 psi, then the spring force forcing the seal 32 against the upwardly facing rim 30 is 37.5 pounds (0.10 square inches×375 psi).

When the pressure in the tank exceeds a predetermined amount, the pressure on the seal 32 exceeds the compressive force of the spring 36, causing the seal 32 to unseat from the upwardly facing rim 30. The contents of the tank is then allowed to vent between the unseated seal 32 and the upwardly facing rim 30 and into the atmosphere. When the venting reduces the tank pressure to a safe level, the spring pressure overcomes the internal pressure of the cylinder against the seal, and the spring pressure reseats the seal 32 against the upwardly facing rim 30, thereby sealing the internal cavity 101 of the cylinder from the atmosphere.

Typically, the pressure relief valve is designed to meet CGA S-1.1-2011 (and revisions thereof) and CG-7 PRV requirements. Depending on the cylinder design rating, the internal pressure of the cylinder may start to unseat the seal and vent the cylinder at any specified pressure typically between 100 and 10,000 psi. A typical start to discharge pressure is 375 psi. The reseating pressure is typically less than the start to discharge pressure, is typically between 85% and 95% of the start to discharge pressure and is more typically about 90% of the start to discharge pressure. The PRV is typically sized, based on cylinder design, capacity, and contents, to release a minimum flow per minute, typically measured in units of cubic feet per minute (cfm). One typical minimum flow rating is 151 cfm at 480 psi.

In the embodiment described here, the PRV is assembled before affixing it to the tank with a process that generates minimal heat or localizes heat generated so the seal 32 is not compromised in the affixing process. On method of affixing the pressure relief valve to the cylinder with minimal or localized heat is projection welding. The projection welding process is a modified spot welding process where the weld is localized by means of raised sections on one or both of the pieces to be joined.

FIG. 5 shows one type of a resistance welder that may be used to projection weld the PRV 10 to the top portion 120 of the cylinder, an H-Frame resistance AC welder 200. The welder 200 has a first structural sidewall 202 and a second structural sidewall 204. An upper support 206 and a lower support 208 are connected to the sidewalls 202 and 204. The upper support 206 supports a movable upper electrode system 210. The movable upper electrode system 210 has an upper electrode 212, a shield 214 disposed in front of the upper electrode 212, and an actuator 216 for moving the electrode 212 up and down in the direction of arrows 218 and 220, respectively. The actuator may be a hydraulic cylinder, an air cylinder, or other actuator able to supply the force necessary to complete the projection welding process. The upper electrode is typically made of copper. A first flexible conductor 222 is electrically connected to the upper electrode 212 by a fastening system 226 and to supplied power by a fastening system 228. A second flexible conductor 224 is electrically connected to the upper electrode 212 by a fastening system 230 and to supplied power by a fastening system 232. The first flexible conductor 222 and the second flexible conductor 224 are typically made of thin flexible sheets of copper or copper wire.

The lower support 208 has a lower electrode 234 held by an electrode holder 235 mounted to a base 236 affixed to the lower support 208. The lower electrode 234 is typically copper and is liquid cooled. While the coolant is typically water or a water based coolant, other coolants may be used. The coolant flows in and out through coolant lines 238 and 240. The upper electrode 212 may also be liquid cooled. Additionally, the upper electrode 212 could be fixed and the lower electrode 234 could be movable in the direction of arrows 218 and 220.

FIG. 6 provides an enlarged view of the base 236, electrode holder 235, and electrode 234. The electrode 234 has a substantially hollow upper end 246 formed by a cylindrical wall 242 that terminates in a rim 244. The rim 244 has an inside diameter 248 that is typically smaller than the diameter 158 of the projection 150 and is large enough to allow the sloped sidewalls 146 of the formed pocket 142 to drop into the substantially hollow upper end 246 so that a lower face 151 proximate the projection 150 of the outer portion 148 rests on the rim 244.

The PRV is projection welded to the upper portion 120 of the cylinder 100 prior to welding the upper portion 120 and the lower portion 130 of the cylinder 100 together. To weld the PRV to the upper portion 120, the upper portion 120 is placed on the lower electrode 234 with the sloped sidewalls 146 of the formed pocket 142 located in the substantially hollow upper end 246 of the lower electrode and the lower face 151 resting on the rim 244 of the lower electrode. The projection 150 is typically located substantially directly above the rim 244. The PRV is then deposited in the PRV receiving area 140 of the upper portion 120. Typically, at least a part of the sidewall 18 of the housing 12 passes through the aperture 112. Alternatively, the PRV can be deposited in the upper portion 120 before the upper portion 120 is placed on the lower electrode 234.

With the PRV deposited in the upper portion 120, the flange 20 of the PRV, having a diameter 22 that is larger than the diameter 158 of the projection 150, rests on top of the projection. The welding process is then initiated by activating the actuator 216 to drive the upper electrode 212 toward the PRV 10. The upper electrode 212 moves downward in the direction of arrow 220, ultimately contacting the flange 20 of the PRV. Downward movement continues until the actuator 216 pushes the flange against the projection 150 with a force typically between 500 and 10,000 pounds, more typically between 1500 and 8000 lbs, more typically between 2500 and 6500 lbs, and most typically between 3500 and 5500 pounds.

The welder depicted here is an AC welder, with one electrode being a “ground” electrode and one electrode being a “hot” electrode. Typically, the upper electrode 212 is the hot electrode and the lower electrode 234 is the ground electrode. While force is being applied to the upper electrode 212 by the actuator 216, electrical power is supplied to the upper electrode. Because the upper electrode and the lower electrode are typically copper, and the flange 20, the projection 150 and the upper portion 120 are steel, the resistance is higher where the projection 150 meets the flange 20 than it is where the upper electrode meets the flange and where the lower electrode meets the lower face 151. Additionally the surface area contact between the upper electrode 212 and the flange 20 and between the lower electrode 234 and the lower face 151 is greater than the surface area contact between the projection and the flange. Thus, the greatest resistance occurs where the projection 150 contacts the flange 20.

The electrical power passes from the upper electrode 212 and through the flange 20. The upper portion 120 is relatively well grounded by the contact between the rim 244 of the lower electrode 234 and the lower face 151. Thus, when the power meets relatively high resistance where the projection 150 meets the flange 20, sufficient heat is generated to melt the metal of the projection 150 and the flange 20 where the projection meets the flange, thereby forming a projection weld 141 and welding the PRV to the upper portion 120. The welding amperage supplied is typically between 35,000 and 125,000 amps, more typically between 50,000 and 110,000 amps, and most typically between 65,000 and 95,000 amps. The supply voltage is typically between 9 and 15 volts, more typically between 10 and 14 volts, and most typically between 11 and 13 volts. The welding duration is relatively short and can be measured in cycles, where 1 cycle is 1/60^{th} of a second. The welding duration is typically between 3 and 16 cycles, more typically between 5 and 14 cycles, and most typically between 7 and 12 cycles. More or less voltage, amperage, pressure, and time may be needed depending on the type of material being welded, the thickness of the material, and other factors. After the PRV is welded to the upper portion 120, the upper electrode retracts in the direction of arrow 218, and the upper portion with the PRV welded to it is removed from the welder.

The projection welding, in part because of its short duration, produces a localized heat concentrated where the projection meets the flange. As such, the heat does not reach the seal 32 of the PRV 10 in sufficient quantities to damage the seal 32. Thus, the PRV can be assembled prior to welding it to the upper portion 120 of the cylinder 100. After welding the preassembled PRV to the upper portion 120, the lower rim 126 of the upper portion is welded to the upper rim 136 of the lower portion 130 to form a cylinder 100.

While the present invention has been illustrated by the description of embodiments thereof, and while the embodiments have been described in considerable detail, it is not intended to restrict or in any way limit the scope of the appended claims to such detail. Additional advantages and modifications will be readily apparent to those skilled in the art. The invention is therefore not limited to the specific details, representative apparatus and method, and illustrated examples shown and described. Accordingly, departures may be made from such details without departing from the scope or spirit of the invention.

What is claimed is:

1. A pressure relievable tank comprising:
a. a cylinder,
b. a pressure relief valve having a housing with an upper end, a lower end and a sidewall disposed therebetween, a flange connected the upper end of the housing, and a bottom having a central aperture and an upwardly facing rim surrounding the central aperture, whereas the bottom is connected to the lower end of the housing and the bottom and sidewall form a cavity,
c. a retainer fixed in the upper end of the housing, a seal disposed in the lower end of the housing, and a spring compressed between the retainer and the seal for holding the seal against the upwardly facing rim, and
d. a projection weld welding the flange to the cylinder.

2. The pressure relievable tank of claim 1, wherein the cylinder has an upper portion and a lower portion, the upper portion including a pressure relief valve receiving area having a substantially circular projection with an upper edge.

3. The pressure relievable tank of claim 2, wherein a diameter of the upper edge of the substantially circular projection is less than a diameter of the flange of the pressure relief valve.

4. The pressure relievable tank of claim 1, wherein the seal is a rubber seal.

5. The pressure relievable tank of claim 1, further comprising a safety seat disposed between spring and the seal.

6. The pressure relievable tank of claim 2, wherein the pressure relief valve receiving area has an outer portion with an outer surface, and the projection extends above the outer surface a distance between 0.027 and 0.033 inches.

7. A process of manufacturing a pressure relievable tank, comprising:
a. providing a first cylinder component having a pressure relief valve receiving area, whereas the pressure relief valve receiving area has a projection and defines an aperture,
b. providing a pressure relief valve having a housing with an upper end, a lower end and a sidewall disposed therebetween, a flange connected the upper end of the housing, a bottom having a central aperture and an upwardly facing rim surrounding the central aperture, whereas the bottom is connected to the lower end of the housing and the bottom and sidewall form a cavity,
c. providing a welder with an upper electrode and a lower electrode,
d. placing the first cylinder component in the welder with a lower face of the pressure relief valve receiving area resting on the lower electrode,
e. depositing the pressure relief valve in the pressure relief valve receiving area,
f. moving the upper electrode towards the lower electrode,
g. pushing the flange of the pressure relief valve against the projection with the upper electrode, and
h. projection welding the flange to the cylinder component where the projection meets the flange.

8. The process of manufacturing a pressure relievable tank according to claim 7, wherein the first cylinder component is an upper portion of a cylinder.

9. The process of manufacturing a pressure relievable tank according to claim 8, further comprising welding the upper portion of a cylinder to a lower portion of a cylinder.

10. The process of manufacturing a pressure relievable tank according to claim 8, further comprising pushing the flange of the pressure relief valve against the projection with a force between 3500 and 5500 pounds.

11. The process of manufacturing a pressure relievable tank according to claim 8, further comprising supplying a projection welding amperage between 65,000 and 95,000 amps.

12. The process of manufacturing a pressure relievable tank according to claim 8, wherein projection welding occurs for a duration between 7/60 and 12/60 of a second.

13. The process of manufacturing a pressure relievable tank according to claim 8, further comprising providing a projection welding voltage between 11 and 13 volts.
